(19) United States
(12) Patent Application Publication
(10) Pub. No.: US 2015/0325058 A1
(43) Pub. Date: Nov. 12, 2015

(54) METHOD AND SYSTEM FOR CONTROLLING ACCESS TO A STATION FOR AUTOMATED RENTAL OF VEHICLES SITUATED WITHIN A STRUCTURE ACCESS TO WHICH IS CONTROLLED

(71) Applicant: BLUECARSHARING, Vaucresson (FR)

(72) Inventors: Clement Lambrinos, Montreuil (FR); Yousra Chebbi, Issy-les-Moulineaux (FR); Aymeric Augustin, Ville d'Avray (FR); Raphael Barrois, Paris (FR); Sylvain Geron, Meudon (FR); Antoine Geron, Viroflay (FR); Thierry Georgeon, Andresy (FR); Francis Aaron, Houilles (FR)

(21) Appl. No.: 14/650,346

(22) PCT Filed: Nov. 20, 2013
(86) PCT No.: PCT/EP2013/074301

§ 371 Date: Jun. 8, 2015

(30) Foreign Application Priority Data
Dec. 14, 2012 (FR) 1262060

(51) Int. Cl. G07B 15/04

(52) U.S. Cl. CPC G07B 15/04

(57) ABSTRACT

A method is provided for controlling access to an automated vehicle rental station including at least one rental vehicle parking location, the station being situated within a structure access to which is controlled by a passage control device disposed at at least one entrance/exit of the structure, the passage control device being movable between an open position permitting passage and a closed position prohibiting passage, the method including a permission phase, including the following steps: —acquisition of an identifier of the user by an acquisition device disposed at an entrance/exit of the structure, —transmission of the identifier to a remote server through a communication network, —verification of at least one condition relating to the user to grant or deny passage, and —command of the passage control device, disposed at the entrance/exit of the structure, as a verification of the at least one condition.

The present invention relates to a method for controlling access to a station for the automated rental of vehicles situated within a structure the access to which is controlled, such as for example a private car park or a car park for which payment is required, in particular an underground car park. It also relates to a system implementing such a method.

The field of the invention is the field of controlling access to a service for the automated rental of vehicles in a structure the access to which is controlled, either because such a structure is a private structure to which access by the members of this structure is authorized, or because this structure offers a service for which payment is required, other than the automated vehicle rental service. Such a structure can be a private car park the access to which is reserved for certain users, a car park requiring payment accessible to the public, in particular an underground car park, a closed structure for entry to which payment is required, such as for example a leisure park or other, etc.

### STATE OF THE ART

Automated vehicle rental is a field experiencing rapid growth. In population centres where it is desirable to reduce the number of vehicles present in the area, automated vehicle rental systems are being established.

The automated rental of vehicles, and more particularly of electric vehicles, and even more particularly electric cars, requires automated rental stations including parking spaces for parking the vehicles available for rental before or after rental.

The automated vehicle rental service is intended to be available to a large number of users without the need for them to travel long distances. Thus, it is necessary to provide a large number of rental stations in town centres where the number of users is greatest and where the space available to provide rental stations is restricted.

Moreover, it is necessary to protect the rental stations against malicious acts and acts of vandalism by controlling access to these rental stations.

All these considerations have led actors in this field to provide rental stations in car parks or more particularly in underground car parks, or any other structure the access to which is controlled and capable of offering the space necessary to provide a rental station including one or more parking spaces. This solution makes it possible to give protection against acts of vandalism and to respond to the need for availability of the rental service to users.

However, this solution poses on the one hand, the problem of the ability to access the rental station since it is located within a structure the access to which is controlled, and on the other hand, the problem of the control and regulation of the access within the structure in which the rental station is located. It will be noted that the main difficulty is to ensure that a rental service vehicle has access free of charge to a structure which normally only permits paid-for access.

There is currently no method and system allowing the regulation and control of access to a station for the automated rental of vehicles situated within a structure the access to which is controlled.

A purpose of the invention is to overcome this drawback.

A purpose of the present invention is to propose a method and a system for controlling access to a station for the automated rental of vehicles situated within a structure access to which, namely the entry and/or exit, is controlled.

### DISCLOSURE OF THE INVENTION

The invention proposes to achieve at least one of the aforementioned purposes by a method for controlling access to a rental station of a service for the automated rental of vehicles comprising at least one parking space for a vehicle available for rental, said station being situated within a structure the access to which is controlled, for example a car park and more particularly an underground car park, by a passage control device, the structure comprising at least one parking space not belonging to the station and access to which is not reserved for the users of the rental service, the passage device being arranged at at least one entry/exit of said structure, being able to move between an open position authorizing passage and a closed position prohibiting passage, such as for example a barrier or a gate for cars or also a pedestrian access door, said method comprising a phase called authorization phase, comprising the following steps:
acquisition of an identifier of said user in order to identify said user to said rental service by an acquisition means arranged at an entry/exit of said structure, for example a chip card reader, an RFID reader or a keyboard for entering an identifier,
transmission of said identifier to a server of the rental service remote from said structure, and in communication with the structure over a communications network,
verification by said server of at least one condition relating to said user in order to grant or refuse passage to said user,
operating the passage control device, arranged at said entry of said structure, depending on the result of said verification of said at least one condition.

The verification is in particular carried out in a database relating to the rental service, fully independent of the infrastructure of the structure.

Thus, the method according to the invention allows a user to enter/exit a station for the automated rental of vehicles located in a structure, such as a car park, the access to which is controlled, without being obliged to use or to subscribe to a service available within the structure other than the automated rental service.

Moreover, the method according to the invention makes it possible to regulate and control this access depending on at least one condition; in other words a means of identification proving that an individual is a rental service user is not sufficient. Such a regulation makes it possible not to give access to the structure to all users of the rental service but to select the users of the service who actually need to access the rental station located in the structure. Thus, the method according to the invention makes it possible to prevent fraudulent use of a service available within the structure other than the automated rental service of which they are users. In the specific case where the structure is a car park, the method according to the invention makes it possible to prevent fraudulent use of the car park for example by preventing rental service users from accessing the structure in order to park their personal vehicle there and not for purposes associated with the automated rental service.

Moreover, the method according to the invention is implemented at the entry/exit of the structure which makes it possible to avoid installing another dedicated mechanism for controlling access to the rental station inside the structure.

Advantageously, the passage control device can be operated:
directly by the remote server, said remote server being directly connected to the passage control device, and/or
by the acquisition means following receipt of an item of data, called authorization data, from the remote server, and/or
by a local server of said structure following receipt of an item of data, called authorization data, from the remote server, the item of authorization data being able to be received directly from the remote server or via the acquisition means.

Such a local server can communicate with the remote server either directly or via the acquisition means.

Advantageously, when the authorization phase is carried out following a request to enter the structure, the method according to the invention can moreover comprise, before the step of operating the passage control device, an additional step of verification of at least one condition relating to the rental station, said command step also depending on the result of said additional verification.

Thus, the method according to the invention makes it possible to carry out regulation of entry to the structure both with respect to the user and also with respect to the rental station situated within this structure, which makes it possible to give a user access to the structure when the user requires a service which can actually be offered to him by the rental station located in this structure. The method thus makes it possible to avoid giving access to users who ultimately could not be accommodated by the rental station, and to limit the number of users of the rental service entering the structure.

In a particular embodiment that is in no way limitative, when the authorization phase is carried out following a request to enter the structure, the condition relating to the rental station can involve an item of data relating to:
the presence or absence of a vehicle available for rental in said rental station, in particular if the user arrives at a pedestrian entrance of the structure, and/or
the presence or absence of a car parking space available in said station, in particular in the case where the user arrives at a vehicle entrance of the car park.

In a particular embodiment that is in no way limitative, when the authorization phase is carried out following a request to enter the structure, the at least one condition relating to the user can involve an item of data relating to:
validity or invalidity of a subscription taken out by said user, and/or
a presence or absence of a current rental of a vehicle, and/or
a presence or absence of a current reservation of a vehicle, and/or
a presence or absence of a current reservation of a parking space.

When access to the structure is authorized, the method according to the invention can also comprise storing in the remote server in association with the identifier of said user:
the entry time of said user to said structure, and
an authorized duration of stay of said user within said structure.

Thus, the method according to the invention makes it possible to monitor the duration of stay of the user in the structure and to undertake appropriate actions depending on this period. This is suitable in particular for authorizing the user to enter the structure with his vehicle even if the station has no parking space available, in order to avoid the need for him to carry out complex manoeuvres in order to exit the car park, such as reversing. Thus even in this case, provision can be made for the user to exit the structure within the defined time slot, or he could be billed by the structure.

When the authorization phase is carried out following a request to exit said structure with a vehicle, the method according to the invention can further comprise, before the command step, an additional step of verification of at least one condition relating to said vehicle, said command step also depending on the result of said additional verification.

Thus, the method according to the invention also makes it possible to carry out a control at the exit of the structure in order to avoid improper use of the structure by the users of the structure. When the structure is a car park, the method according to the invention makes it possible on the one hand, to avoid improper use of the car park by a rental service user for parking purposes independently of the rental service and on the other hand, to bar a user who for unknown reasons has been unable to return a rented vehicle to the rental station for example because no parking space is available in the rental station.

The condition relating to said vehicle can involve an item of data measured by a sensor of the vehicle, for example a movement sensor, in order to verify if the vehicle is in motion or not, and if the user has in fact rented a vehicle. This avoids a misuse situation in which the user attempts to leave the structure with his own vehicle or another vehicle unconnected with the rental service,

When the authorization phase is carried out following a request to exit said structure, the at least one condition relating to the user verified during an exit phase can involve an item of data relating to:
validity or invalidity of a subscription taken out by said user, and/or
a presence or absence of a current rental of a vehicle, and/or the authorized duration of stay stored beforehand for said user, and/or
the total time elapsed between entry and exit of said user.

Such a verification makes it possible for the user to leave the structure again without having to pay a sum corresponding to the time of presence in the structure when he has been unable to return his rented vehicle, and on the other hand to prevent the user subscribed to the rental service using the structure in an unauthorized manner independently of the rental service.

In the case in which the structure is a car park, and the user did not arrive at the exit before the end of the predetermined period of authorized presence, the method according to the invention makes it possible, in association with the car park, to bill the user.

The method according to the invention can be used, in a preferred application, for the management of controlled access to a car park and more particularly to an underground car park comprising a station for the automated rental of vehicles, said car park authorizing access to users other than the users of the rental service associated with said rental station.

According to another aspect of the invention, a system is proposed for controlling access to a station for the automated rental of vehicles comprising at least one parking space for a vehicle available for rental, said station being situated within a structure the access to which is controlled, for example a car park and more particularly an underground car park, by a passage control device arranged at at least one entry/exit of said structure and being able to move between an open position authorizing passage and a closed position prohibiting passage, such as for example a barrier or a gate for cars or also a access door for pedestrians, said system comprising:
at least one means of acquisition of an identifier of said user arranged at an entry/exit of said structure, for example a chip card reader, an RFID reader or a keyboard for entering an identifier,
a remote device for verifying at least one condition relating to said user by consulting at least one database depending on said identifier, and
at least one means of operating said passage control device depending on the result of said verification of said at least one condition.

Advantageously, the acquisition means can be a first type when arranged at a pedestrian entry/exit of the structure and a second type when arranged at a vehicle entry/exit of the structure.

Advantageously, the acquisition means can be a first type when it is arranged at an entrance to the structure and a second type when it is arranged at an exit from the structure.

The system according to the invention can also comprise at least one means of acquisition of an identifier of said user arranged at an exit from said structure, for example a chip card reader, an RFID reader or a keyboard for entering an identifier, making it possible to identify the user when he leaves the structure with a vehicle and a means of acquisition of an identifier of said user arranged at an entrance to said structure, for example a chip card reader, an RFID reader or a keyboard for entering an identifier, making it possible to identify the user when he enters the structure with a vehicle or on foot.

The passage control device can be a door, in particular at the pedestrian entrance of the car park, or a barrier, in particular at a vehicle entrance or exit of the car park.

According to the invention, at least one command means can comprise a command module configured to operate the passage control device, and means of communication between said command module and said passage control device.

The command module can be arranged in the acquisition means, in the remote server or also in a local management server of said structure.

The command module can communicate directly with the command device, either by a wired connection or by wireless connection means.

The command module can also communicate with the command device via the acquisition means and/or via a management server of the structure, for example a local server.

The invention also relates to a closed car park, i.e. having controlled access, comprising at least one vehicle rental station, equipped with a system for controlling access according to the invention.

Other advantages and features of the invention will become apparent on examination of the detailed description of embodiments which are in no way limitative, and the attached drawings, in which:

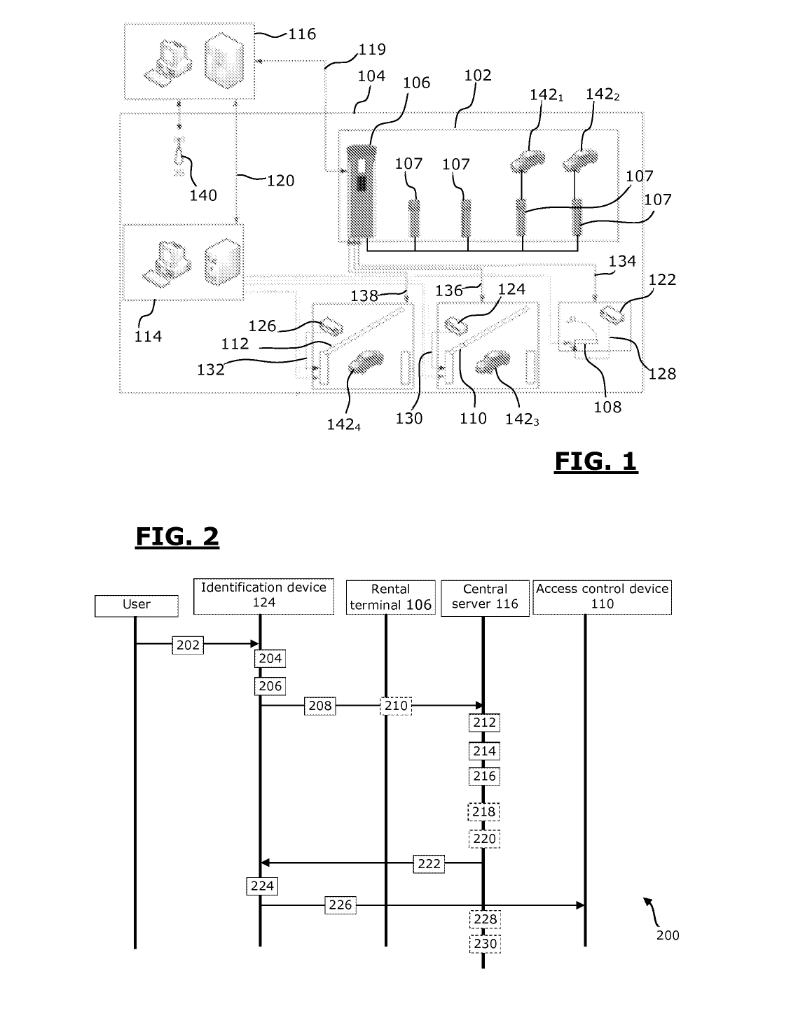

FIG. 1 is a diagrammatic representation of a system for controlling access according to the invention to a station for the automated rental of a vehicle located in an underground car park; and

FIGS. 2-5 are diagrammatic representations of a method for controlling access according to the invention to a station for the automated rental of a vehicle located in an underground car park, for different situations.

It is well understood that the embodiments described hereinafter are in no way limitative. Variants of the invention can in particular be envisaged comprising only a selection of the features described below in isolation from the other described features, if this selection of features is sufficient to confer a technical advantage or to differentiate the invention from the state of the prior art. This selection comprises at least one preferred functional feature without structural details, or with only a part of the structural details if this part alone is sufficient to confer a technical advantage or to differentiate the invention from the state of the prior art.

In particular, all the described variants and embodiments can be combined if there is no objection to this combination from a technical point of view.

FIG. 1 is a diagrammatic representation of a system according to the invention for controlling access to a station for the automated rental of a vehicle located in a car park.

The system 100 allows controlled access to a station 102 for the automated rental of electric vehicles situated within a car park 104 having controlled or restricted access.

The rental station 102 comprises at least one rental terminal 106 making it possible to carry out interactions with the users of the rental service.

Each rental terminal 106 is linked to charging terminals 107 for recharging the electric vehicles parked in the rental station 102 in rental parking spaces not shown).

The car park 104 comprises a device 108 for controlling entry to and exit from the car park for pedestrians, which is in the present example an access door 108, a device for controlling entry to the car park 104 for vehicles which is a barrier 110 and a device for controlling exit from the car park 104 for vehicles which is a barrier 112. Each device 108, 110 and 112 for controlling access can be moved between an open position authorizing passage and a closed position prohibiting passage. Moreover, each device can be operated remotely by a remote device by means of a communication over a wired or other connection.

The car park 104 also comprises a server 114 for management of the car park, and in particular for operating the opening or closing of the access control devices 108-112, in the case where a conventional user arrives at one of the control devices.

The system 100 also comprises a central server 116, placed at a site remote from the car park. The server 116 is linked to the rental terminal 106 of the rental station 102 by a wired connection or otherwise, over a communications network embodied by the line 119. The server 116 is also connected either by the same network or by a different network represented by a line 120 to the server 114 of the car park 104. The server :116 is for example a central server of the rental service. It stores in particular numerous items of data relating to the use of the service and to its different components (vehicle, user, station, etc.).

The system also comprises a device 122-126 for the acquisition of an item of identification data of a user, arranged at each access device 108-112 to the car park. Each acquisition device 122-126 can be an alphanumeric keyboard, an RFID card reader or a chip card or also a reader of an item of biometric data. In the example shown in FIG. 1, an RFID card reader, 122-126 respectively, is arranged at each passage control device, 108-112 respectively.

Each RFID reader 122-126 has a wired connection, by a line 128-132 respectively, to the access control device 108-112 with which it is associated, and can operate the opening and closing of the passage device 108-112 via lines 128-132. Thus, the RFID reader 122 is connected to the pedestrian access door 108 via a line 128, the RFID reader 124 is connected to the vehicle entrance barrier 110 via line 130 and the RFID reader 126 is connected to the vehicle exit barrier 112 via a line 132.

Each RFID reader 122-126 is also connected to the rental terminal 106 by a data link, respectively 134-138, wired or otherwise, and communicates directly with the rental terminal :106 and with the central server 116 by means of the rental terminal 106.

Each RFID reader 122-126 also comprises user interface means such as a screen, a keyboard, a microphone and a loudspeaker and optionally one or more illuminated signalling means, such as diodes.

The system also comprises a gateway 140 for wireless connection to the central server 116 allowing vehicles available for rental 1421, 1422 that are located at the rental station 102 in the car park 104 to communicate using a wireless communication with the server 116. The gateway 140 also allows a rented vehicle 1423 entering the car park 104 or a rented vehicle 1424 exiting the car park 104 to engage in wireless communication with the central server 116. In the example shown in FIG. 1, the gateway 140 is a communication gateway using the GPRS network, and is for example an extension of the existing GPRS network or a repeater of this network.

Each vehicle 142 comprises means for connecting to the charging terminals 108 in order to recharge, for example an electric plug and optionally an electric cable. Each vehicle also comprises specific equipment for the rental service, for example a reader of a means of identification of the RFID type, etc.

The central server 116 is also connected to the server 114 of the car park 104 by a wired connection or otherwise represented by the line 144.

Optionally the car park 104 can comprise one or more other rental stations (not shown) which can each comprise a rental terminal (not shown). According to a first version each rental terminal of the other rental stations can be connected to the central server 116. According to a second version, each rental terminal of the other rental stations can be a “slave” terminal connected to the rental terminal 106 which is then a “master” terminal. This means that only the master rental terminal 106 is connected directly to the central server 116, the slave rental terminals being connected to the central server 116 through the master rental terminal 106. In this case, the exchanges between the slave rental terminals and the central server 116 take place via the master rental terminal 106. The master rental terminal 106 then forms a gateway between the slave rental terminals and the central server 116.

Several embodiments of a method according to the invention in different configurations will now be described:
the case of a user who enters the car park with a vehicle,
the case of a pedestrian who enters the car park in order to use the rental service,
the case of a user who exits the car park with a rental vehicle.

FIG. 2 is a diagrammatic representation of a method according to the invention in the case of a user wishing to:
access the car park 104 by the pedestrian entrance, or
access the car park 104 by the vehicle entrance, or
exit the car park 104 by a vehicle exit.

The method 200 shown in FIG. 2 comprises a step 202 during which the user presents a means of identification, for example an RFID badge comprising an item of identification data, called identifier, at one of the identification devices 122-126, which in the present example are each an RFID reader.

The RFID reader 122-126 reads the identifier in step 204 and in step 208 transfers the read identifier to the central server 116 via the rental terminal 106, for example in a message prepared in a previous step 206.

The message is created with the read identifier and optionally an identifier of the RFID reader 124 and an identifier of the rental terminal 106, the identifier of the latter being able to be indicated directly by the RFID reader 122-126 or added to the message by the rental terminal 106, when the message transits therethrough, in a step 210.

When it receives the message, in a step 212 the central server 116 consults the number of the reader and deduces the type of reader concerned, using a database relating to the identification devices.

Depending on the type of identification device, the central server 116 deduces the condition(s) that it must check in order to determine if the user is authorized to enter the car park.

In the case where the reader identified is:
the reader 122, the central server 116 executes a verification sequence called “pedestrian entry”.
the reader 124, the central server 116 executes a verification sequence called “vehicle entry”, or
the reader 126, the central server 116 executes a verification sequence called “vehicle exit”.

The central server 116 takes account of the type of reader and in a step 214, executes the verification sequence associated with the reader.

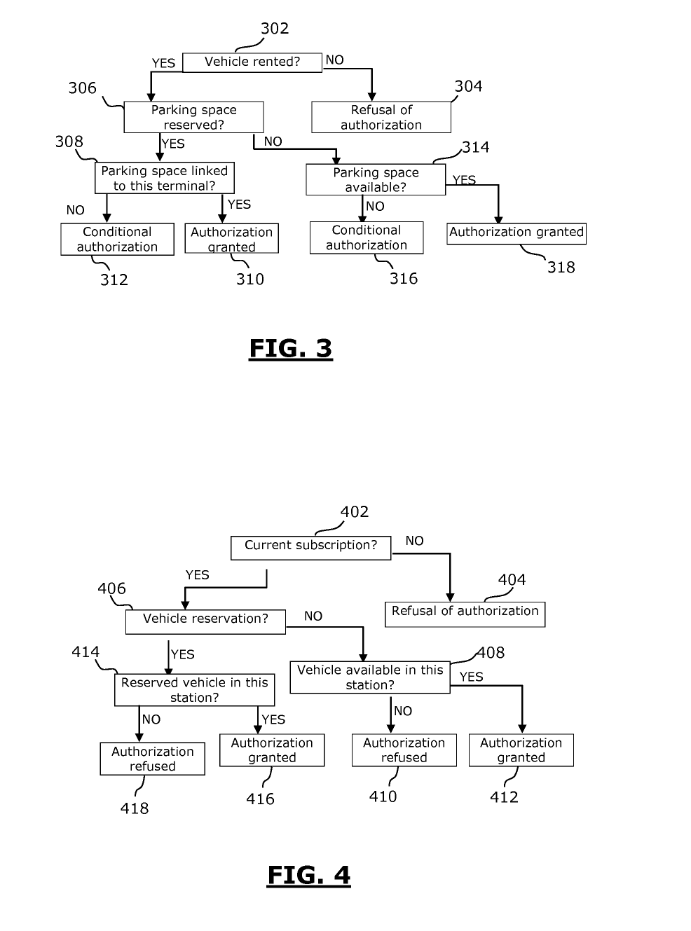

Each of these sequences is described later with reference to FIGS. 3-5.

At the end of step 214 of execution of the verification sequence, in a step 222 the central server 116 sends a message prepared in a previous step 216 to the RFID reader concerned, indicating the result of the determination step, still via the rental terminal 106.

When step 214 results in a refusal of authorization, the message sent in step 222 contains an item of refusal data and in a step 224 the RFID reader concerned displays this refusal to the user, using for example a screen or illuminated means capable of displaying at least 2 different colours.

The screen can also display a message inviting the user to take a ticket, and the method stops,

When the determination step 214 results in authorization, the message sent in step 222 comprises an item of authorization granted data. In this case, in step 224 the RFID reader concerned displays the authorization granted result.

In step 226, the RFID reader 124 sends a signal to the moveable element associated with the RFID reader via an electrical switch linking the reader to a component, such as a motor or an actuator for example, in order to activate this component, allowing the moveable element 110 to move to open position in step 224.

Before sending the message to the reader, in an optional step 218 the central server 116 also stores:
the user's time of entry to the car park 104 and associates an “active” status with this time, which means that the user has neither parked his vehicle nor left the car park, or
the user's time of exit from the car park 104 and associates a “terminated” status with this time, which means that the user has left the car park 104 with a rental vehicle.

When the authorization determined in step 214 is conditional (as described below), the same steps are carried out. Furthermore, during an optional step 220, an item of time data relating to the predetermined period for which the user is authorized to remain in the car park 104 could be associated. This step 220 is optional, because the predetermined period could be applied for any vehicle which enters the car park, whether the authorization is conditional or not.

In the case of conditional authorization, the message issued for the attention of the user could also be different from the message displayed in the case of an item of information, for example when the user is informed that no parking space is available or that he has a reservation elsewhere and the time of his authorized presence in the car park is indicated to him.

In the case of an access request by a vehicle entrance, when the user is authorized to enter the car park 104 and he has no reserved parking space, the method can comprise, before authorizing the user to enter the car park 104, a step asking him if he wishes to reserve a parking space or requiring him to reserve one. In this case, the RFID reader sends the user's identifier to the central server with a request to reserve a parking space. The central server associates the user's identifier with an identifier of a parking space in its database and sends it back to the reader which also indicates to the user, via its screen, the number of the reserved parking space, for example the identifier of a charging terminal associated with the parking space. Alternatively, the number of the parking space can be notified to the user via a user's mobile terminal, for example by means of a digital address of the user recorded beforehand in the central server 116.

In the case of an access request by a vehicle entrance in which the user is authorized to enter the car park in order to plug in his vehicle, it will be noted that on return of the vehicle, once all the steps have been carried out correctly, the central server 104 changes the status associated with the entry time from the “active” to the “terminated” state during an optional step 228.

In the case of an access request by a vehicle entrance in which the user is authorized to enter the car park in order to plug in his vehicle, the central server 104 can carry out various actions, in an optional step 230, if it notes that at the end of a predetermined period the vehicle is still considered to be rented, such as:
sending a message to a user's mobile terminal to let him know that that the vehicle is not properly connected,
sending a message to an operator on site in order to verify the status of the vehicle,
billing the user for the time spent by the vehicle in the car park.

In this case, the central server 116 interacts with the car park server 114 in order to report the irregularity to it, determining the current charge, and being capable of billing this charge to the user correctly.

Different verification sequences will now be described which can be carried out by the central server 116 in step 214.

FIG. 3 is a diagrammatic representation of the “vehicle entry” sequence checked by the central server 116 when a vehicle entry request is made.

The reader concerned is the reader 124 and the access authorization device is the barrier 110.

In a step 302, the central server 116 verifies, depending on the user's identifier, if the user is renting a vehicle.

To this end, the central server 116 verifies, in a database of the central server 116, that the user's identifier is associated with a vehicle identifier.

If this is not the case, in a step 304, the central server 114 transmits an Item of access authorization refusal data.

If the user's identifier is associated with a vehicle identifier, the central server 116 verifies if the user has a reserved parking space in the rental station 102 by consulting the rental terminal 106, in a step 306.

This verification can also be carried out by consulting a database in the central server 116 in which the user's identifier is associated with a rental parking space.

If the central server 116 notes that the user has a reserved parking space, in a step 308, the identifier of the rental terminal of the station where the parking space is reserved, stored with the user's identifier, is compared with the identifier of the rental terminal of the station 102 from which the message (sent from step 208) requesting access to the car park 104 originates.

If the parking space is in fact reserved at the rental station 102, in a step 310 the central server transmits an item of authorization data for access to the car park 104.

If the parking space is not reserved at the rental station 102, in a step 312 the central server 116 transmits an item of authorization data, allowing the user to enter the car park regardless, in order to avoid an unintentional user having to pay for access to the car park. This authorization is however a conditional authorization which only allows the user to remain in the car park for a predetermined period, for example 5 or 10 minutes, so that he can exit without paying.

If the central server 116 notes that the user has no reserved parking space, the central server 116 verifies, in a step 314, if there is an available parking space in the rental station 102. To this end, the central server extracts the number of the rental terminal from the message received (sent in step 208) and extracts, for this number, an item of data relating to the availability of the parking spaces (for example, number of parking spaces available or a Boolean item of data showing the parking space state as available or not) from a database in which this item of data was stored beforehand. These availability data are acquired beforehand in real time using information uploaded directly from each of the terminals

If no available parking spaces remain, in a step 316, the central server 116 delivers a conditional authorization, as described above.

If available parking spaces remain, in a step 318, the central server 116 transmits an item of authorization data, allowing the user to enter the car park 104 in order to park his vehicle in the rental station 102.

Alternatively, it is possible for the conditional authorization not to be sent, or not to be sent in certain cases, for example when there is no current subscription, etc.

FIG. 4 is a diagrammatic representation of a “pedestrian entry” sequence checked by the central server 116 when a request is made for a pedestrian entry.

The reader concerned is the reader 122 and the access authorization device is the door 108.

The central server 116 verifies, in a step 402, if the user has a current subscription. This is done by consulting a database of the central server 116 which updates the subscription status of the users.

If the subscription is not current, in a step 404, the central server transmits an item of data refusing authorization.

If the subscription is current, the central server 116 verifies, in a step 406, if the user has a vehicle reserved at the rental terminal 106 by consulting a database of the central server 116. As the reservation was made beforehand following a procedure which is not detailed here, at least one item of data, associated with the user and proving the reservation of a vehicle and its reservation location is shown in the database.

If the central server notes that the user does not have a vehicle reserved, the central server 116 verifies, in a step 408, if the rental station 102 comprises vehicles available for rental. To this end, the central server 116 extracts:
from the message received (in step 208 FIG. 2) the number of the rental terminal from which the message originates, then
from a database in which it was stored beforehand, an item of data relating to the availability of the vehicles (for example, number of vehicles available or a Boolean item of data showing the vehicle status, available or not), these data being acquired in real time using information uploaded directly from each of the rental terminals.

If no available vehicles remain, in step 410 the central server 116 delivers an item of access authorization refusal data.

If available vehicles remain, in step 412 the central server 116 delivers an item of access authorization acceptance data.

If the central server :116 notes at the end of step 406 that the user has a vehicle reserved, in a step 414 it compares the identifier of the rental station 102 with which the vehicle reserved by the user is associated, by consulting a database at the central server 116 (this database being supplied with data uploaded from the different real-time rental elements) with the identifier of the station from which the message originates (in step 208).

If the vehicle is in fact reserved at the rental terminal 106 of the station 102, in step 416, the central server 116 transmits an item of data accepting authorization and authorizes the user to enter the car park 104.

Otherwise, in step 418 the central server 116 transmits an item of data refusing authorization and does not authorize the user to enter the car park.

After having executed the “pedestrian entry” sequence, steps 216, 222, 224 and optionally 226 are carried out as described above with the RFID reader 122 and the passage control device 108.

When the user is authorized to enter the car park, before authorizing his entry, the central server 116 can ask him if he wishes to reserve a vehicle (or require him to reserve one).

In this case, the reader 122 sends the user's identifier to the central server 116. The central server 116 chooses the vehicle from the car park most suitable for the user according to different criteria (battery charge, etc.) and associates the user's identifier with the identifier of the vehicle in its database.

The central server 116 also informs the user of the number of the reserved vehicle (for example its registration plate), via the reader 122 or a user's mobile terminal, a digital address of the user being in this case recorded beforehand in the central server 116.

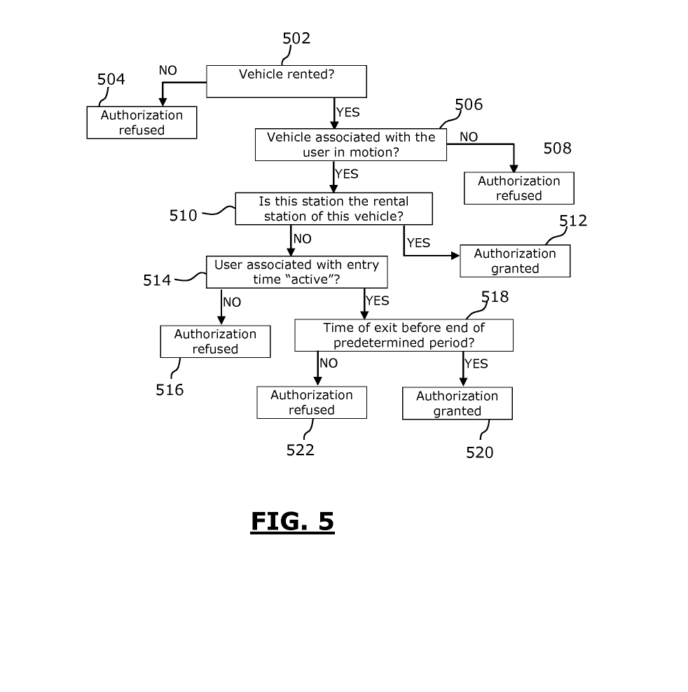

FIG. 5 is a diagrammatic representation of a “vehicle exit” sequence checked by the central server 116 when a request is made at the reader 126 to exit the car park 104 with a vehicle.

The reader concerned is the reader 126 and the access authorization device is the barrier 112.

The central server 116 verifies in a step 502 if the user is renting a vehicle. To this end, the central server 116 verifies, in a database of the central server 116, that the user's identifier is associated with a vehicle identifier.

If this is not the case, in a step 504 the central server 116 transmits an item of data refusing authorization to exit the car park.

If on the other hand, the user's identifier is associated with a vehicle identifier, the vehicle is indeed rented. In this case, in a step 506 the central server 116 verifies that the vehicle with which the user's identifier is associated in its database is in fact in motion. To this end, the central server 116 sends a message to the vehicle concerned by means of a wireless network, for example the GPRS network, optionally via the connection gateway 140, requests it to transfer to the central server 116 the data from a sensor making it possible to determine if the vehicle is in motion, such as an accelerometer, a position sensor situated at the level of the wheel, an engine start sensor, etc. This sensor sends the data acquired via a CAN bus of the vehicle, connected to a communication box allowing the vehicle to communicate with the central server 116 using the GPRS network. These data can also alternatively be uploaded in real time to the central server 116 and stored in an associated database: in this case the central server 116 will simply consult this database.

Depending on the data received, the central server 116 is capable of determining, by comparing the values of these sensors with threshold or predetermined values, if the vehicle is actually in motion.

If the vehicle is not in motion, in step 508, the central server 116 transmits an item of data refusing authorization.

If the vehicle is in motion, in a step 510 the central server 116 verifies if the rental station in which the vehicle was hired is the one corresponding to the rental station from which the message received in step 208 originated, To this end, as explained above, the central server 116 compares the identifier of the station 102 and the identifier of the departure station of the vehicle associated with the user, the latter identifier being stored in a database at the central server 116.

If the two identifiers are identical, in step 512 the central server 116 transmits an item of data accepting authorization,

If this is not the case, the central server 116 verifies, in step 514, if an entry time to the car park 104 was recorded for the user and is associated with an “active” status for said user, in steps 218 and 220 described below which would have been carried out in a phase of entry to the car park 104.

If this is not the case, in step 516 the central server 116 transmits an item of data refusing authorization.

If this is the case, the effective period between the entry time to the car park and the present time is compared, in a step 518, to the predetermined period of authorization of presence on the car park 104.

If the effective period is less than the predetermined period, in a step 520, the central server 116 transmits an item of data accepting authorization.

If the effective period is greater than the predetermined period, in a step 522, the central server 116 transmits an item of data refusing authorization.

The invention is of course not limited to what has been described.

It is possible, for example, for readers not to be located at the pedestrian entrances of the car park.

The conditions can also be different from what has been described or can be verified in a different order: for example, concerning the pedestrian entrance, it is also possible to verify, if the user no longer has a current subscription, if he still has a current rental (which makes it possible to cover the case where he has forgotten to plug in the vehicle and is returning in order to do so). It is also possible for the reservation conditions not be verified at the different entrances. Similarly, it is possible for the vehicle in motion condition not to be verified at the vehicle exit.

It is also possible not to offer invoicing of the car park by means of the vehicle rental service. In this case, when fraud occurs, the user can be directly requested to contact the car park staff. Similarly, reservation is not necessarily offered to the user on entering the car park.

It is also possible for the readers not to operate the opening of the doors or barriers. The operation can be carried out by the car park management server, the latter being in communication with the central server.

Similarly, the different conditions verified can be sent in a request prepared at the reader. It can then be envisaged that the reader carries out the authorization step and informs the central server of it.

1. A method for controlling access to a rental station of an automated vehicle rental service, the station comprising at least one parking space for a vehicle available for rental, said station being situated within a structure the access to which is controlled by a passage control device arranged at at least one entry/exit of said structure, the structure comprising at least one parking space not belonging to the station and access to which is not reserved for the users of the rental service, said passage control device being able to move between an open position authorizing passage and a closed position prohibiting passage, said method comprising a phase called authorization phase, comprising the following steps:
acquisition of an identifier of said user in order to identify said user to said rental service by an acquisition means arranged at an entry/exit of said structure;
transmission of said identifier to a server of the rental service remote from said structure and in communication with the station over a communications network;
verification by the remote server of at least one condition relating to said user in order to grant or refuse passage to said user; and
operating the passage control device arranged at said entry/exit of said structure, depending on the result of said verification of said at least one condition.

2. The method according to claim 1, characterized in that the operation of the passage control device is carried out:
directly by the remote server, said remote server being directly connected to the passage control device; and/or
by the acquisition means following receipt of an item of data, called authorization data, from the remote server; and/or
by a local server of said structure following receipt of an item of data, called authorization data, from the remote server.

3. The method according to claim 1, characterized in that, when the authorization phase is carried out following a request to enter the structure, the at least one condition relating to the user involves an item of data relating to:
validity or invalidity of a subscription taken out by said user; and/or
a presence or absence of a current rental of a vehicle; and/or
a presence or absence of a current reservation of a vehicle; and/or
a presence or absence of a current reservation of a parking space.

4. The method according to claim 1, characterized in that, when the authorization phase is carried out following a request to enter the structure, it comprises storing, in the remote server, in association with the identifier of said user:
the entry time of said user to said structure when access is granted to a user; and
an authorized duration of stay of said user within said structure.

5. The method according to claim 1, characterized in that, when the authorization phase is carried out following a request to enter the structure, it also comprises, before the command step, a step of additional verification of least one condition relating to the rental station, said command step also depending on the result of said additional verification.

6. The method according to claim 5, characterized in that the condition relating to the rental station involves an item of data relating to:
the presence or absence of a vehicle available for rental in said station; and/or
the presence or absence of an available parking space in said station.

7. The method according to claim 1, characterized in that, when the authorization phase is carried out following a request to exit said structure with a vehicle, the at least one condition relating to the user involves an item of data relating to:
validity or invalidity of a subscription taken out by said user; and/or
a presence or absence of a current rental of a vehicle; and/or
the authorized duration of stay previously stored for said user, and/or
the total time elapsed between entry and exit of said user.

8. The method according to claim 1, characterized in that, when the authorization phase is carried out following a request to exit said structure with a vehicle, it also comprises, before the command step, a step of additional verification of at least one condition relating to said vehicle, said command step also depending on the result of said additional verification.

9. The method according to claim 8, characterized in that the at least one condition relating to the vehicle involves an item of data measured by a movement sensor arranged on the vehicle in order to verify if said vehicle is in motion or not.

10. The method according to claim 1 for management of access control of a car park and more particularly an underground car park comprising a station for the automated rental of vehicles, said car park authorizing access to users other than the users of the rental service associated with said rental station.

11. A system for controlling access to a station for the automated rental of vehicles, comprising at least one parking space for a vehicle available for rental, said station situated within a structure the access to which is controlled by a passage control device arranged at at least one entry/exit of said structure and being able to move between an open position authorizing passage and a closed position prohibiting passage, said system comprising:
at least one means of acquisition of an identifier of said user arranged at an entry/exit of said structure;
a remote device for verifying at least one condition relating to said user by consulting at least one database depending on said identifier; and
at least one means of operating said passage control device depending on said verification of said at least one condition.

12. The system according to claim 11, characterized in that it also comprises at least one means of acquisition of an identifier of said user arranged at an entrance to said structure and at least one means of acquisition of an identifier of said user arranged at an exit of said structure.

13. The system according to claim 11, characterized in that at least one command means comprises a command module configured to operate the passage control device, and means of communication between said command module and said passage control device.

14. A closed car park comprising at least one vehicle rental station, equipped:
with an access control system according to claim 11, or
means for implementing the steps of the method according to claim 1.
